(19) United States
(12) Patent Application Publication
(10) Pub. No.: US 2010/0145297 A1
(43) Pub. Date: Jun. 10, 2010

(54) SINGLE DOSE MEDICATION CONTAINER

(76) Inventor: Margarita Aguilo-Pinedo, Lake Worth, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/633,310

(22) Filed: Dec. 8, 2009

Related U.S. Application Data
(60) Provisional application No. 61/120,653, filed on Dec. 8, 2008.

(51) Int. Cl. A61J 1/18

(52) U.S. Cl. 604/404

(57) ABSTRACT

A portable shatter-proof container for liquid medication is adapted for measuring, labeling, and dispensing single dosages of prescribed medication. The apparatus is comprised of a three-dimensional graduated tube having a snap-closure lid and a base for allowing the apparatus to stand upright. The tube has graduated marks in imperial and metric measurements and can hold a reasonable volume, i.e. one dose, of liquid. With its rectangular shape, the narrow length contains the graduated markings of imperial measurement on one side and metric markings on the opposing side. The wider front includes an adhesive label for writing information such as patient name, date, contents, and dosing instructions. Liquid medicine is poured directly from the original medicine bottle into the apparatus, thereby allowing for measurement of contents as it is filled. The snap-closure lid allows the container to be transported, without concern of spillage. The contents are then consumed by drinking the measured liquid from the disposable container.

### CROSS REFERENCE TO RELATED APPLICATIONS

This application claims the benefit of provisional U.S. patent application Ser. No. 61/120,653, filed on Dec. 8, 2008.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to apparatus for use in measuring and dispensing liquid medication, and more particularly to a shatter-proof and disposable container for single-dosage quantities that is portable and provides identification of contents, patient, and dosing instructions.

2. Description of Related Art

A medicine vial, also frequently called a medicine bottle, is a container used to hold or store medicinal substances in either liquid or capsule form. Such apparatus are generally formed of glass or plastic, and are equipped with various closure methods, such as the screw-on cap, cork stopper or snap-closure lid. Medicinal substances, whether prescribed or purchased over-the-counter, are pre-filled into such containers. These traditional medicine bottles tend to hold several doses of medicine, such that a patient orally takes a portion of the bottle's contents and retains future doses in the original packaging.

Individuals, from the elderly to infants, ingest a variety of medicines throughout their lifetime. Absent a serious illness which requires confinement to bed-rest, the majority of patients are prescribed treatment which is taken during the course of a typical clay. Even when prescribed an antibiotic, adults and children often engage in the normal activities of daily life. As a result, many people attempt to adhere to the dosing schedule while being away from home. Generally, it is not desirable to transport the entire bottle of medicine in order to take a dose at the proper time during the day. This is particularly true with school-aged children, who are not permitted to store bottles of medicine at their desk and/or where the medication needs to be refrigerated at the school nurse's office. School policies require an attending nurse or teacher to administer the required dose. Unless specific instructions are provided, including identification of the substance, to whom it belongs, and when and the quantity of dose is needed, medicines could be confused among children, or entire prescription bottles lost or broken in transport. Such method provides great risk for improper dosing or potential spillage.

A limitation of the present art is such that individual dosages of medicine, liquids in particular, are not easily identifiable or transportable once removed from the original packaging. As human consumption of medicine is widespread and because society requires mobility, an apparatus for ease of use in measuring, storing, labeling, and transporting liquid medication is desirable. Prior art does not reveal a functional solution to this issue.

The background art reveals a number of attempts directed to providing efficient devices for measuring and administering medicine. Such devices generally require a multi-step process whereby the medicine must be pre-measured and then stored in a separate storage container. For example, U.S. Pat. No. 3,302,644, issued to Kennedy et al. discloses a cup and measuring spoon for dispensing to children. The device is adapted for mixing medicine and other liquid to dilute or wash-down the dose. U.S. Design Patent No. 224,260, issued to Squibb & Sons, Inc., discloses an updated dispenser spoon. Such device is an open-ended vial with a modified spoon attached. U.S. Pat. No. 4,581,013, issued to Allen, discloses a device for orally administering medication with capability of dilution of dosage with a non-medicinal liquid. Additionally, a label on which patient information may be written is disclosed. U.S. Pat. No. 5,037,389, issued to Dooley, discloses a dispenser with an internal trough mechanism which slides to allow medicine to be poured from the vial into the recipient's mouth. U.S. Design Patent No. 328,492, issued to Mathis, discloses a cup-like device with outwardly channeled groove for pouring and affixed measurement graduations on the side thereof U.S. Pat. No. 5,377,879, issued to Isaacs, discloses a device that utilizes a plunger apparatus located inside the vial to push the required dose onto a connected spoon. Several other disclosed improvements including U.S. Pat. Nos. 4,129,228, issued to Stoneback; 4,475,654, issued to Fruchter; and 5,953,288, issued to Chappell, relate to transport of pill or tablet formulations.

The devices of the background art are generally suitable for the intended purposes for which they are primarily designed, but each include limitations and disadvantages that have limited commercial success. More particularly, the background art fail to provide a shatter-proof, transportable, and disposable apparatus adapted for all-in-one measuring, storing, and dispensing of liquid medication from a container adapted to allows for proper labeling of the contents, patient's name, and dosing information.

### BRIEF SUMMARY OF THE INVENTION

The present invention overcomes the limitations and disadvantages present in the art by providing a portable spill-resistant single dose liquid medication container. The apparatus includes a rectangular shaped vial having an enlarged base for stability and hinged lid with snap-closure to sealingly cover a tapered dispensing spout. The container has graduated measurements for measuring proper volume of contents which precludes the need for additional measuring devices OT pre-measuring. The apparatus preferably includes a label affixed to one length of the vial, allowing for the consumer to write the patient's name, dosing instructions, and other pertinent information. In a preferred embodiment, the container is constructed of a shatter-proof material, such as hard plastic. The vial shall hold a reasonable amount of liquid medication, such that the apparatus is intended for single-dose usage.

Accordingly, it is an object of the present invention to provide an improved container for transporting liquid medication.

Another object of the present invention is to provide such an apparatus adapted with a measuring device so that the medication can be measured and stored in one step.

Still another object of the present invention is to provide such an apparatus adapted to provide an adhesive substrate material for the application of alpha and numeric indicia such as name, dosage instructions, and other pertinent information.

Yet another object of the present invention is to provide such an apparatus adapted for transportation of the liquid without breakage of the container or spillage of its contents.

Yet another object of the present invention is to provide a means by which school-age children, travelling adults, or the elderly can have access to their medication while away from home, without transporting excess doses.

These and other objects are met by the present invention which will become more apparent from the accompanying drawing and the following detailed description of the drawings and preferred embodiments.

### BRIEF DESCRIPTION OF THE SEVERAL VIEWS OF THE DRAWINGS

FIG. 1 is a front view of a portable medication container in accordance with the present invention;

FIG. 2 is a side view thereof;

FIG. 3 is an opposing side view thereof; and

FIG. 4 is a top view thereof.

### DETAILED DESCRIPTION OF THE INVENTION

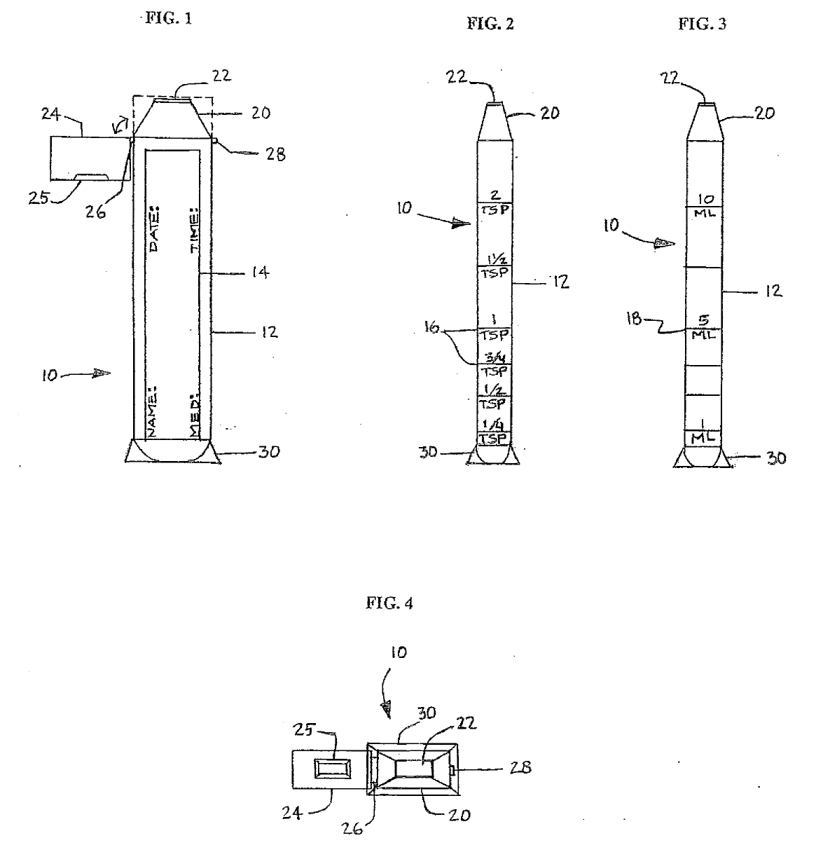

With reference now to the drawings, FIGS. 1-4 depict a spill-resistant, shatter-proof portable liquid medication container, generally referenced as 10, in accordance with the present invention. Container 10 is specifically adapted for self-contained measuring, transporting, identification, and dispensing of liquid medication.

As best seen in FIG. 1, container 10 includes a main vial body 12 that is preferably rectangular in cross-section and hollow. Vial body 12 preferably defines a rectangular cross-section formed by a first opposing pair of sidewalls having a first width and a second opposing pair of sidewalls having a second width, with the first width being greater than the second width. Providing a rectangular cross-section is important to provide a vial body having at least one the first opposing pair of sidewalls is substantially flat so as to provide a surface upon which written information may be applied by a user. Accordingly, vial 12 is user adaptable with a simple writing instrument to include patient's name, dosing instructions, and other pertinent information. Vial body 12 is sufficiently sized to hold a reasonable amount (typical dosage) of liquid medication. Providing a rectangular cross-section is further important to provide a vial body having at least one the second opposing pair of sidewalls to include graduation markings to identify volume corresponding to fill level.

FIG. 1 depicts a front view of apparatus 10 and reveals that vial body 12 defines a substantially planar sidewall having an outer surface adapted with an indicia receiving substrate or surface 14 capable of receiving alpha-numeric information such that individualized information, including name and dosing instructions may be printed thereon. Substrate 14 comprises any suitable material upon which written information may be applied, such as an adhesively affixed label. In an alternate embodiment, substrate may comprise a surface suitable for receiving indicia written in ink, pencil, or permanent or erasable marker.

FIG. 2 depicts a side view of apparatus 10 wherein vial body 12 is adapted with indicia indicative of measurements of volume, generally referenced as 16. Such capacity for volume should be reasonable for a single-dose of liquid medication for adults and/or children. FIG. 3 depicts an opposing side view of apparatus 10 wherein vial body 12 is adapted with metric measurements of volume, generally referenced as 18. In accordance with a preferred embodiment, the vial body 12 and the corresponding volume capacity is reasonable for a single-dose of liquid medication for adults and/or children. Any suitable units of measure, such as English units (e.g. fluid ounce or fraction thereof, teaspoon or table spoon), metric units (e.g. ml) may be used with the present invention.

As best illustrated in FIGS. 1-3, vial body 12 includes a top portion 20 defining an opening 22, and a base 30. Top portion 20 is preferably tapered to opening 22 such that top portion 20 forms a dispensing spout that functions to allow the user, particularly children, to easily dispense the contents into his/her mouth. An openable closure lid 24 is connected proximal top portion 20 by a hinged connection, referenced as 26. FIG. 1 depicts lid 24 in the open position in solid line, and in the closed position in phantom line. Lid 24 preferably includes a resilient seal 25 structured to provide sealing engagement with opening 22 when in the closed position to prevent leakage. Resilient seal 25 preferably comprises a soft plastic or rubber material. In a preferred embodiment, the undersurface of the planer top-portion of lid 24, and particularly resilient seal 25 sealingly engages with the top portion 20, and particularly the uppermost peripheral edge thereof forming opening 22 to prevent leakage of the vial contents into lid 24 in the event that the container is inverted or tipped. A closure tab 28 may be provided to engage lid 24 and provide a releasable snap closure. Base 30 preferably projects laterally from a bottom portion of vial 12, and includes a substantially flat bottom surface that supports the vial in a generally vertically disposed/upright position, such that it reduces the opportunity for unexpected spillage.

Finally, FIG. 4 illustrates a top view of container apparatus 10 with the lid 24 in the open configuration. It should be noted that opening 22 should be of sufficient size to allow for contents to be poured into vial body 12 without requiring special filling accessories or additional instruments. In a contemplated alternate embodiment, top portion 20 may also be connected to vial body 12 by a hinged connection to allow top portion 20 to be pivotally moved to an open configuration thereby exposing an enlarged opening for filling vial body 12.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A portable single dose liquid medicine container comprising:
a vial having a top portion defining an opening, and a bottom portion including a base, said vial having sidewalls defining a generally rectangular cross-section formed by a first pair of opposing sidewalls and a second pair of opposing sidewalls;
at least one of said first pair of sidewalls having an outer surface having an indicia receiving surface;
each of said second pair of opposing sidewalls including indicia indicative of measurements of volume;
said top portion including a tapered opening forming a dispensing spout;
a closure pivotally connected proximal said top portion, said closure manually configurable between open and closed positions, said closure forming a generally fluid tight seal with said opening when in the closed position; and
said base projecting from the bottom portion of said vial and including a substantially flat bottom surface that supports the vial in an upright position.

2. A portable single dose liquid medicine container according to claim 1, wherein said closure comprises a lid having a resilient seal structured to provided sealing engagement with said opening.

3. A portable single dose liquid medicine container according to claim 1, wherein said vial top portion defines an inward taper terminating at said opening so as to form a spout.

4. A portable single dose liquid medicine container according to claim 1, wherein said base projects outward from said vial and includes a substantially flat bottom surface.

5. A portable single dose liquid medicine container comprising:
a vial having a top portion and a bottom portion;
said top portion being inwardly tapered and terminating at opening;
said bottom portion including a base having a peripherally extending substantially flat bottom surface;
said vial having sidewalls, including a first pair of opposing sidewalls and a second pair of opposing sidewalls, defining a generally rectangular cross-section;
at least one sidewall of said first pair of sidewalls having an outer surface having an indicia receiving substrate;
each of said second pair of opposing sidewalls including indicia indicative of measurements of volume;
a closure pivotally connected proximal said top portion, said closure manually configurable between open and closed positions, said closure forming a generally fluid tight seal with said opening when in the closed position; and
said base projecting from the bottom portion of said vial and including a substantially flat bottom surface that supports the vial in an upright position.

6. A portable single dose liquid medicine container according to claim 5, wherein said closure comprises a lid having a resilient seal structured to provided sealing engagement with said opening when in the closed position.

7. A portable single dose liquid medicine container according to claim 5, wherein said vial is fabricated from shatter-resistant, generally transparent plastic.
